(19) United States
(12) Patent Application Publication
(10) Pub. No.: US 2004/0180574 A1
(43) Pub. Date: Sep. 16, 2004

(54) Stacked connector assembly

(76) Inventor: Richard Liu, Taoyuan Hsien (TW)

Correspondence Address: RABIN & BERDO, P.C., Suite 500, 1101 14 Street, N.W., Washington, DC, 20005, US

(21) Appl. No.: 10/384,722

(22) Filed: Mar. 11, 2003

(51) Int. Cl. H01R 13/60

(52) U.S. Cl. 439/541.5

(57) ABSTRACT

A stackable connector assembly for transmitting audio and video signal and configured by a module, terminals and metal shielding, characterized in that the module is configured by three stacked housings and a base plate, wherein at least one of the housing is configured as an optical connector, while the other two housings are configured as analog signal connector. Those three housings are assembled firstly, and then the base plate is attached from the bottom direction so as to fixedly secure the connector assembly.

### FIELD OF THE INVENTION

The present invention relates to a stacked connector assembly, and more particularly to a connectors assembly having an optical connector and two analog video connectors. The stacked connector assembly features a compact dimension so as to reduce usage of a printed circuit board on which the connector assembly is mounted.

### DESCRIPTION OF THE PRIOR ART

Conventionally, an audio connector mounted to a computer system is an analog connector (a) which is generally embodied with two audio connectors stacked together, such as shown in FIG. 5. However, more and more optical connector (b) has been incorporated in the computer system so as to transmit digital data of video. As a result, it has become a trend to incorporate the optical connector to the computer system. Accordingly, the optical connector has become a standard device for the modern computer system. As shown in FIG. 4, when those two connectors are assembled to the printed circuit board, both take a certain surface area of the printed circuit board. As a result, it doubles the usage of the surface area. In addition, parts of those two connectors are overlapped as well thereby increasing the manufacturing cost. For example, assembling processes have to be done separately, and each of the connectors needs their own shielding. This does not meet the requirements form the market. There is a room for improving the connectors.

### SUMMARY OF THE INVENTION

It is an object of the present invention to provide a connector assembly in which an optical connector as well as an audio connector are compactly stacked together so as to reduce the surface area needed for mounting the same onto a printed circuit board.

In order to achieve to the object set forth, the main plastic module of the present invention is configured by three stackable plastic housings and a base plate. At least one of the plastic housings is used to configure a fiber optical connector and the other two plastic housings are adapted to configure the analog signal connectors. The bottom housing includes a longitudinal rib with respect to a receiving slot arranged on a bottom face of the middle housing. As such, the middle housing can be attached to the base housing by the engagement between the slot and the rib. The middle housing further includes a rib on a top face thereof. A terminal support is integrally formed with the middle housing. The upper housing is provided with-a slot with respect to the rib of the middle housing so as to attach thereto. The upper housing is also provided with a terminal support. The base plate is provided with three sets of through holes in align with terminal tails of the terminals of the connectors. The connectors are assembled firstly in a stack subassembly, the base plate is assembled to the sub-assembly so as to integrally attach to the connectors.

### BRIEF DESCRIPTION OF THE DRAWINGS

FIG. 1 is an assembled view of the connector assembly in accordance with the present invention;

FIG. 2 is an exploded view of FIG. 1;

FIG. 3 is an exploded view of housings of FIG. 1;

FIG. 4 is an exploded view of a second embodiment in accordance with the present invention; and

FIG. 5 is an illustrational view of conventional connectors.

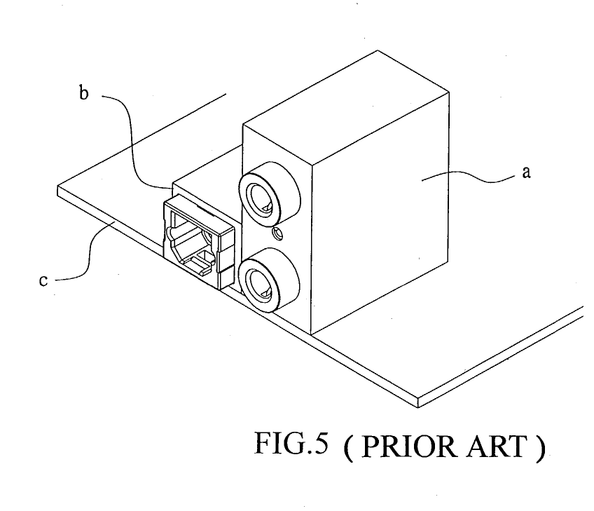

### DETAILED DESCRIPTION OF THE PREFERRED EMBODIMENTS

The present invention can better understood for its features as well as advantages through the description made to a preferred embodiment together with the drawings.

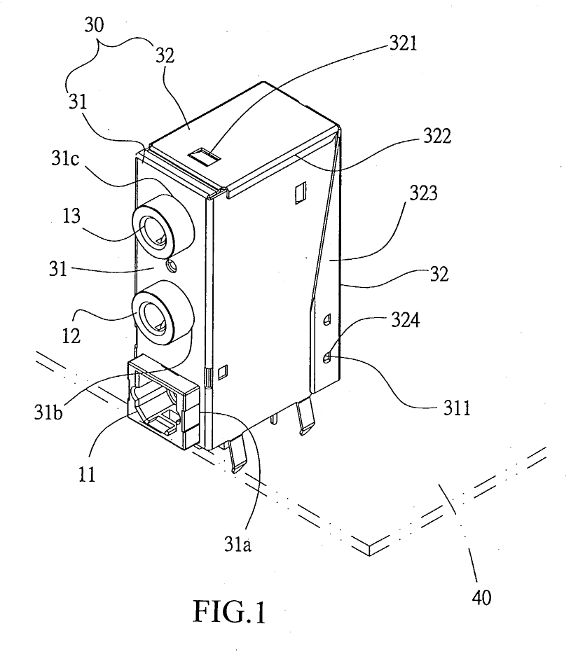

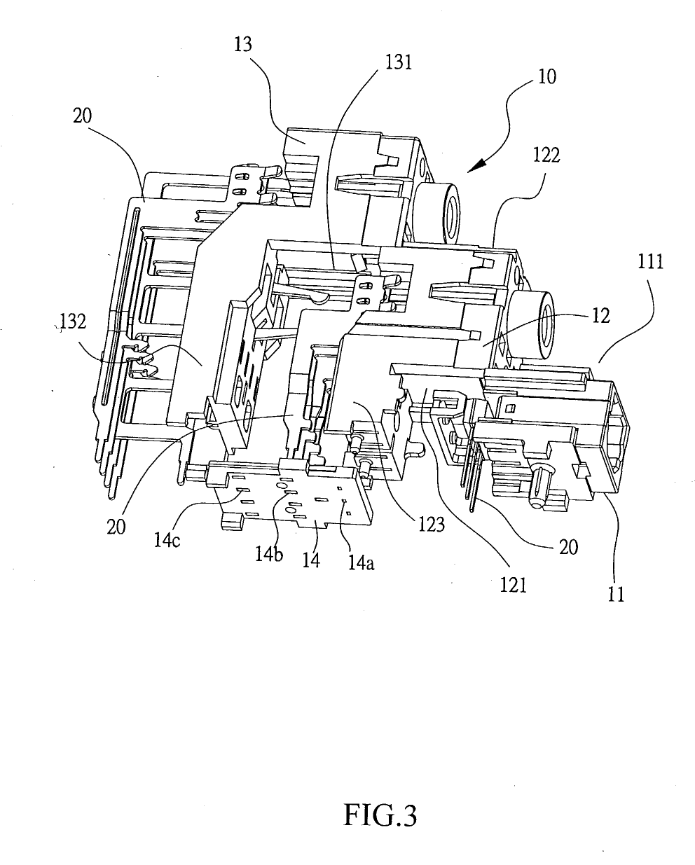

Referring to FIGS. 1 to 3, the stackable connector assembly in accordance with the present invention generally includes a module 10, terminals 20 and metal shielding 30 enclosing the module 10 and the terminals 20. The improvements of the present invention resides in:

The module 10 is configured by first, second and third housings 11, 12, 13 and a base plate 14. The first housing 11 is adapted to be configured as an optical connector, while the second and third plastic housings 12 and 13 are analog connectors. The first housing 11 is provided with a first longitudinal rib 111 on a top face thereof. The second housing 12 is provided with a slot 121 with respect to the longitudinal rib 111 of the first housing at a bottom face thereof. The second housing 12 is therefore attached to the first housing 11 by the engagement between the slot 121 and the rib 111. The second housing 12 is further provided with a second longitudinal rib 122 at a top face thereof. The second housing 12 is further provided with a second terminal support 123 at a rear portion thereof. The third housing 13 is provided with a third slot 131 with respect to the second longitudinal rib 122 of the second housing 12. As a result, the third housing 13 is attached to the second housing 12 by the engagement between the third slot 131 and the second longitudinal rib 122. The third housing 13 is further integrally formed with a third terminal support 132. The base plate 14 is provided with footprints 14a, 14b and 14c each aligns to a corresponding terminal set from the first, second and third housings 11, 12 and 13. In assembly, the first, second and third housings 11, 12 and 13 are firstly assembled to form a sub-assembly, then the base plate 14 is attached to the sub-assembly from the bottom direction so as to form a stacked connector assembly.

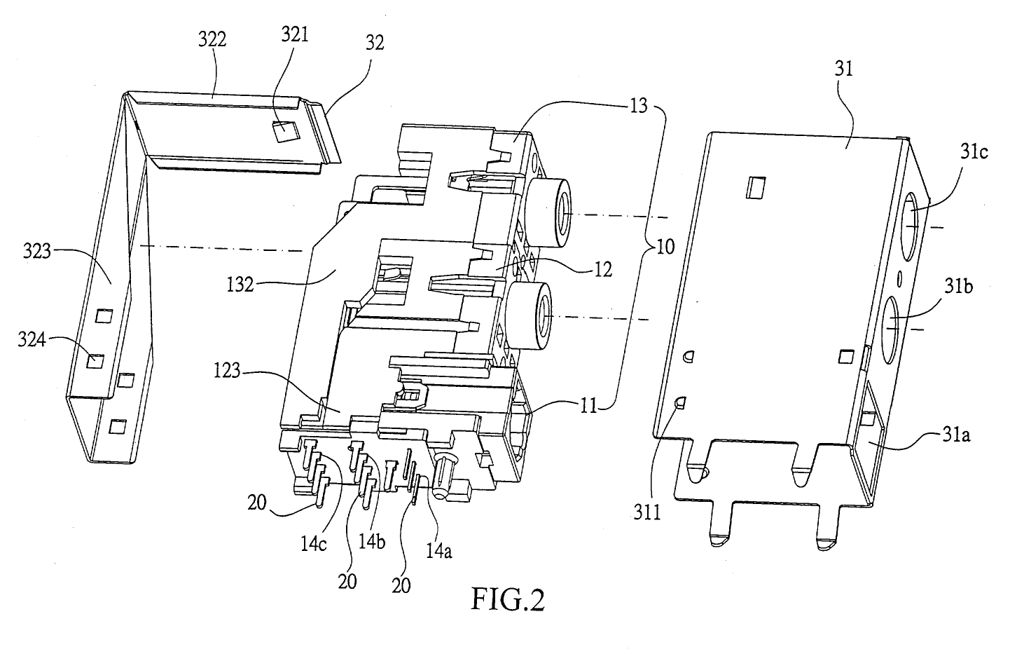

Referring to FIG. 2, the metal shielding 30 is attached to the module so as to provide EMI shielding. The metal shielding 30 is configured by a front panel 31 of “U-shape” and a back panel 32 of “7-shape” attached to the front panel 31. The front panel 31 is provided with first, second and third windows 31 a, 31 b and 31 c with respect to the first, second and third housings 11, 12 and 13. The front panel 31 is further formed with two clips 311. The back panel 32 is configured with a top panel 321 with first side flaps 322 attached thereto. The back panel 32 further includes a pair of second side flap 323 on a back portion thereof. The second side flap 323 has a trapezoid shape. The second side flap 323 is provided with hooking windows 324 so as to engage with the clips 311. In assembly, the front panel 31 is attached to the front face of the module 10 so as to cover its front face and side wall. Then the back panel 32 is assembled to the module 10 from the back direction such that the hooking windows 324 are interlocked with the clips 311. By this arrangement, the metal shielding 30 is assembled to the module 10 providing excellent EMI shielding effect.

During the assembly of the module 10, the terminals 20 or even coupler of fiber can be properly assembled to the first, second and third housings 11, 12 and 13. The terminals 20 are properly supported by the second and third terminal supports 123 and 132 so as to correctly position the pitch of each terminal set. The terminals 20 assembled to the first housing 11 can be bent through 90 degrees. Finally, the footprints 14a, 14b and 14c of the base plate 14 can aligned to terminals 20 so as to fixedly position terminal tails of the terminals 20. Finally, after the metal shielding 30 is enclosed to the module 10 the assembly is done with reduced material used.

Because the fiber connector and the analog connectors are assembled stacked together, the surface area used on the printed circuit board is therefore reduced. In addition, assembling of the fiber connector and the analog connectors to the printed circuit board can be done simultaneously. This will also benefit the time saving on material management, inventory and delivery.

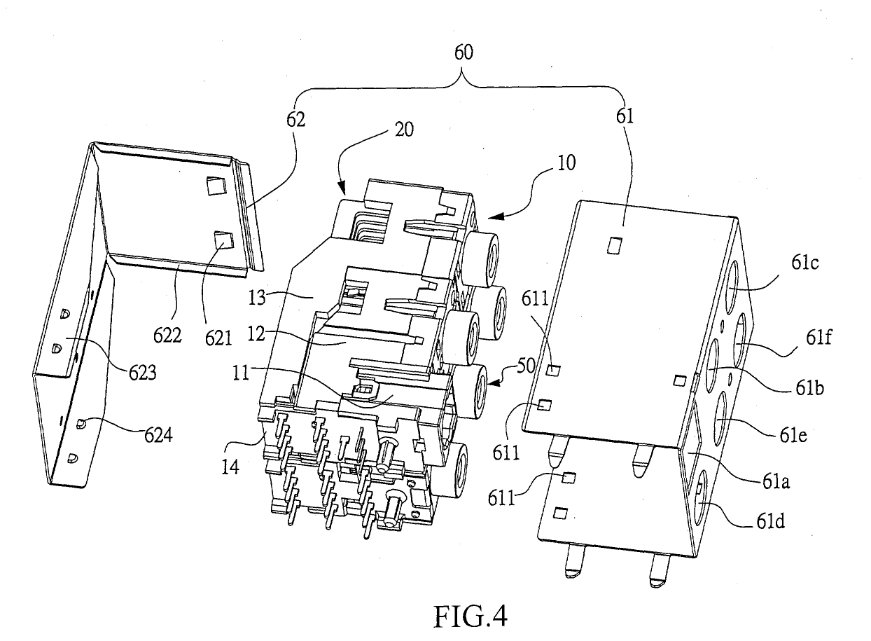

Referring to FIG. 4, the module 10 can be used with another three-port video connector 50. In this case, the metal shielding 60 can be designed accordingly such that the three-port video connector 50 can be included. The metal shielding 60 has a similar configuration such as the metal shielding 30 discussed above, a front panel 61 of “U-shape” and a back panel 62 of “7-shape”. The front panel 61 is formed with totally six (6) windows 61a to 61f corresponding to accessing ports of the connector 50. The front panel 61 is also provided with a pair of hooking windows 611. The back panel 62 is formed with a pair of side flaps 623 of trapezoid shape. The side flap 623 is formed with a pair clips 624 corresponding to the hooking windows 611 so as to interlock to each other when assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A stackable connector assembly for transmitting audio and video signal and configured by a module, terminals and metal shielding, characterized in that:
the module is configured by three stacked housings and a base plate, wherein at least one of the housing is configured as an optical connector, while the other two housings are configured as analog signal connector.

2. The stacked connector assembly as recited in claim 1, wherein the module is configured by three stacked housings and a base plate, wherein at least one of the housing is configured as an optical connector, while the other two housings are configured as analog signal connector, wherein the module can be used with a three-port analog signal connector.

3. The stacked connector assembly as recited in claim 1, wherein a first housing is provided with a first longitudinal rib on a top face thereof, a second housing being provided with a second slot with respect to the first longitudinal rib of the first housing at a bottom face thereof, the second housing being further provided with a second longitudinal rib at a top face thereof and a second terminal support at a rear portion thereof, the third housing being provided with a third slot with respect to the second longitudinal rib of the second housing, the third housing being further integrally formed with a third terminal support, the base plate being provided with footprints each aligns to a corresponding terminals from the first, second and third housings for easy assembly.

4. The stacked connector assembly as recited in claim 3, wherein the metal shielding is configured by a front panel of U-shape and a back panel of “7-shape” attached to the front panel, the front panel being provided with first, second and third windows with respect to the first, second and third housings, the front panel being formed with two clips, the back panel being configured with a top panel with first side flaps attached thereto, the back panel including a pair of second side flap on a back portion thereof, the second side flap having a trapezoid shape, the second side flap being provided with hooking windows so as to engage with the clips.

5. The stacked connector assembly as recited in claim 2, wherein a first housing is provided with a first longitudinal rib on a top face thereof, a second housing being provided with a second slot with respect to the first longitudinal rib of the first housing at a bottom face thereof, the second housing being further provided with a second longitudinal rib at a top face thereof and a second terminal support at a rear portion thereof, the third housing being provided with a third slot with respect to the second longitudinal rib of the second housing, the third housing being further integrally formed with a third terminal support, the base plate being provided with footprints each aligns to a corresponding terminals from the first, second and third housings for easy assembly.

6. The stacked connector assembly as recited in claim 5, wherein the metal shielding is configured by a front panel of U-shape and a back panel of “7-shape” attached to the front panel, the front panel being provided with first, second and third windows with respect to the first, second and third housings, the front panel being formed with two clips, the back panel being configured with a top panel with first side flaps attached thereto, the back panel including a pair of second side flap on a back portion thereof, the second side flap having a trapezoid shape, the second side flap being provided with hooking windows so as to engage with the clips.
